(19) United States
(12) Patent Application Publication
(10) Pub. No.: US 2005/0248615 A1
(43) Pub. Date: Nov. 10, 2005

(54) Color-matching accuracy of an individual printer

(75) Inventor: Satoru Ono, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/035,036

(22) Filed: Jan. 14, 2005

(30) Foreign Application Priority Data
Jan. 15, 2004 (JP) 2004-8117

(51) Int. Cl. B41J 2/21

(52) U.S. Cl. 347/43

(57) ABSTRACT

In creating color correction data for the purpose of correcting deviation of color printed by a printing device capable of recording onto a printing medium N types (N is an integer of 2 or greater) of ink drop with different ink levels, recording level specifying data specifying standard ink recording levels for the purpose of performing output at predetermined color values by means of said N types of ink drops is acquired; color value data indicating color values of color to be printed by means of target tone values that specify target color for output by a printing device is acquired; with reference to the color value data, color values of color to be output by means of the target tone values are specified; with reference to the recording level specifying data, for the N types of ink drops, ink recording levels corresponding to said color to be output are specified; and the acquired ink recording levels are associated with the target tone values to create color correction data.

### BACKGROUND OF THE INVENTION

1. Field of the Invention

The present invention relates to technology for improving color matching accuracy of an individual printer when recording N types of ink drops with different ink levels on a printing medium.

2. Description of the Related Art

In printing devices, image colors are typically represented by tone values of each of a plurality of color components, with ink levels recorded onto a printing medium being adjusted by means of tone values. In a given model of printer, a given tone value will ordinarily indicate the same given color, but due to variation among individual printers and the effects of change over time, deviation in output color among devices may occur. Accordingly, in the past there was developed technology for correcting color deviation between a standard device and an individual device (e.g. Unexamined Patent Application 2000-209450, Unexamined Patent Application 2003-182120).

### SUMMARY OF THE INVENTION

With the conventional technology mentioned above, it was not a simple matter to perform correction of color deviation with a high degree of accuracy, while maintaining high image quality. More specifically, according to Patent Citation 1, when correcting color, tone values are corrected with a constant tone value range for each color, whereby correction can be carried out simply. However, with this arrangement, linearity of color and tone value prior to correction tends to be lost, and it may occur that, for certain colors, there is a large change in color per unit change in tone value, whereas for other colors there is only a small change in color per unit change in tone value. Accordingly, problems such as tone collapse and tone jumping may occur.

In Patent Citation 2, in order to perform correction for each type of ink drop in a printing device that uses N types (e.g. large/medium/small) of ink drops, finely tuned color correction is possible. However, since the number of correction targets is equal to the number of ink colors×N, the correction procedure is quite complicated. Additionally, the balance of large/medium/small dots typically has a very large effect on image quality, so balance is determined carefully so as to avoid banding (linear degradation in image quality in an image), bleeding, and so on. Accordingly, modifying the balance of large/medium/small dots once this has been initially set is undesirable in terms of printing with high image quality.

With the foregoing in view, it is an object of the present invention to provide a color correction data creation device, color correction data creation method, color correction data creation program product, printing control device, printing control method, and printing control program product whereby color deviation may be corrected with a high degree of accuracy, while maintaining high image quality.

To achieve the stated object at least in part, the color correction data creation device herein is designed so that, in a printing device capable of ejecting N types of ink drops, correction is not performed for each ink color and each of the N types of ink level (i.e. the number of ink colors×N), but rather performed for each ink color; and so that the predetermined usage level balance of N types of ink drops is preserved. Specifically, there is prepared in advance recording level specifying data that specifies standard ink recording levels for outputting predetermined color values by means of the aforementioned N types of ink drops, and with reference to this data, color correction data is created (the recording levels stipulated by this recording level specifying data are not themselves subjected to correction).

During creation of color correction data, reference is made to the aforementioned recording rate specifying data. Specifically, by referring to the recording rate specifying data, there can be specified recording levels for N types of ink drops (i.e. a balance of ink drops) predetermined for a standard printing device, in order to output predetermined color values. By acquiring the color value of color actually printed by an individual printer by means of specified target tone values, it is possible to ascertain differences between color value of the color that should properly be output by means of these target tone values on the one hand, and the color which is actually output on the other.

As a result, it becomes possible to calculate a correction level for bringing output color in an individual printing device into approximation with the color that should properly be output. Where the correction level has been calculated, it becomes possible by means of referring to the aforementioned recording rate specifying data, to acquire recording levels for N types of ink drops needed to output the corrected color value. Thus, the acquired recording levels for N types of ink drops and the original target tone values are associated to give the color correction data.

Specifically, in the color correction data, there is specified an association relationship between target tone values and recording levels for N types of ink drops for outputting colors that should properly be output with these target tone values. Accordingly, in the case where, referring to this color correction data, any tone values are converted to recording levels for N types of ink drops, it will be possible to acquire ink drop recording levels able to output the correct color that should properly be output with any tone value (i.e. output color close to that of a standard printing device).

Where a plurality of colors are used in a printing device, typically, tone values designating color are determined for each color; in the present invention, however, the task of creating color correction data is not performed for each individual color. Specifically, since recording levels of N types of ink drops are specified simply by referring to recording level specifying data created in advance, there is no need to correct individual recording levels for each of the N types of ink drops. Accordingly, correction can be carried out by means of a simple procedure.

The effects of balance of recording levels of N types of ink drops on image quality are very great, and in the recording rate specifying data, ink drop recording levels are adjusted very finely in order to print high quality images. Accordingly, in the present invention, wherein reference is made to the recording rate specifying data, and recording rates specified by the data are employed as-is without correction (i.e. without changing the ink usage balance of the N types of ink drops specified by the data), it becomes possible to carry out correction of color deviation, while preserving high image quality.

In the present invention, any of various arrangements can be employed as the arrangement for recording N types of ink drops onto a printing medium. Specifically, in this instance it is sufficient for ink drop size (ink drop amount) to be variable, so as to be able to form pixels of different size on the printing medium. Thus, while it is acceptable for N to be 2 or greater, since tone of a single pixel can be represented on 2 bits, an arrangement that uses three types of ink drops is often used.

The recording level specifying data acquiring portion may be any data able to associate ink recording levels for N types of ink drops with color values. For example, table data associating a plurality of color values with recording levels for N types of ink drops; data stipulating a relationship between the two by means of a predetermined function; or any of various other arrangements could be employed. Of course, it is not essential that the table data, function or the like directly associate a relationship between the two; first data that associates color value with a certain value and second data the associates this value with ink recording level could be used for the purpose of associating color values and ink recording levels.

As noted, recording level specifying data can be data specifying standard ink recording levels for outputting predetermined color values. Here, since standard data suffices, it is not necessary for data to reflect individual device differences among individual printing devices. That is, data for a standard device created during manufacture of the printing device etc. is acceptable. While device differences among printing devices are not reflected in the recording level specifying data, in the present invention, individual device differences among printing devices are reflected by means of referring to the color value data.

That is, since color output by a target tone level can exhibit differences among individual printing devices, the color value data acquiring portion acquires color value data indicating the color value of color printed with a certain target tone value. More specifically, the specified target tone value is adjusted so as to output the color of a certain color value at the time of manufacture of the printing device. This output color can change over time, for example. Accordingly, there will arise individual device differences among printing devices prior to adjustment at the time of manufacture, or due to change over time.

Thus, printing is performed by means of target tone values under a condition in which individual device differences have arisen, and the color values of the colors that are actually output are acquired as color value data. By so doing, it is possible to create color correction data so as to compensate for individual device differences. Any of various arrangements may be employed for the purpose of acquiring color value of color output from each printing device by means of specified target tone values; for example, an arrangement wherein patches are printed by the printing device by means of target tone values, and the printed patches are subjected to color measurement with a calorimeter to acquire color value data indicating the measured color values.

In the recording level acquiring portion, it is sufficient to refer to the color value data and recording level specifying data, and acquire ink recording levels (for N types of ink drops) for the purpose of outputting color that should be output by the target tone values. Specifically, since color values of color that should be output by the target tone values are determined in advance, it is sufficient to compare these with color values of color actually output by individual printing devices, to ascertain differences between the two. If differences have arisen, by minimizing these differences to the greatest extent possible while specifying a color value of color outputtable by the individual printing device, a color value that corrects for color deviation can be determined. Once such a color value has been determined, it suffices to refer to the recording level specifying data to acquire the ink recording level that corresponds to the color value in question. As a result, it becomes possible to specify specific target tone values in an individual printing device, and ink recording rates for N types of ink drops that will output color closely approximating the color that should be output with these target tone values.

It suffices that the color correction data creation portion be able to create color correction data indicating an association relationship between target tone values and ink recording rates, from the association relationship between the relevant color values and ink recording rates. Specifically, since recording rates of N types of ink drops for outputting a desired color value in a printing device are specifiable by means of the recording level acquiring portion, and a target tone value for outputting this color value is specified by the color value data, it becomes possible to associate target tone value and ink recording level by means of the two. It suffices that this data can associate the two; it is possible to employ any of various arrangements such as table data or a function associating the relationship of the two.

As noted, in the recording level specifying data it suffices to be able to associate ink recording levels for N types of ink drops with color values; as a specific example, recording level specifying data could be composed of tone value-recording rate conversion data and tone value-color value conversion data. Tone value-recording rate conversion data indicates an association relationship between target tone values and recording levels of each of N types of ink drops that should be printed onto the printing medium when printing target colors indicated by these target tone values, using a standard printing device.

Accordingly, by referring to this association relationship, target tone values can be converted to recording levels of each of N types of ink drops in the standard printing device. This ink drop recording level is the ink drop recording level that should be recorded onto the printing medium in standard printing device, and in most cases is provided to the user for each particular printing device. That is, in printing devices, while it is possible to perform fine adjustment of ink drop ejection levels in order to compensate for individual device differences and the like, since baseline ink levels are stipulated as tone value recording rate conversion data in question and provided for each particular printing device, this data can be utilized to create the aforementioned color correction data.

Tone value-color value conversion data, on the other hand, indicates an association relationship between target tone values and color values of colors printed with a standard printing device by means of these target tone values. Accordingly, by referring to this association relationship, target tone values can be converted to output color values in the standard printing device. The standard printing device is typically a specific device determined by the printing device manufacturer; the manufacturer matches output color of each device to output color of this device in advance.

Given this state of affairs, there are many incidents in which it is difficult for the owner of an individual printing device to know the output color of the standard printing device. Accordingly, the arrangement is one of data creation to give tone value-color value conversion data, which data is then acquired. By means of this arrangement, it becomes possible for even a user who does not own the standard printing device to readily acquire output color in the standard printing device, making it possible to create color correction data for performing color correction to match the output of the standard printing device. With this tone value-color value conversion data it is also possible to specify color values of color that should be output by target tone values.

In order to realize color correction with high accuracy, tone number in the tone value-recording rate conversion data and the tone value-color value conversion data may be adjusted to achieve color correction with higher resolution. Specifically, where tone representation of ink drop recording levels are provided in the tone value-recording rate conversion data, and tone number of the aforementioned target tone values is made smaller than the tone number of tone values indicating ink drop recording levels, ink drop recording levels can be adjusted with high accuracy. More specifically, where ink drop recording levels are defined by multi-tone number, it becomes possible to acquire ink drop recording levels corresponding to small numerical values of target tone values.

In this instance the arrangement is such that, referring to tone value-color value conversion data, an association relationship of target tone values and color values can be calculated accurately for a larger number of values than the tone number of the target tone values. That is, while in the tone value-color value conversion data it is acceptable to specify an association relationship in terms of table data, a function, or any other kind of data, where the arrangement is such that a color value corresponding to a decimal value of target tone values can be calculated, and that color value calculated with a high degree of accuracy, it becomes possible to calculate with a high degree of accuracy the color value corresponding to the target tone value, in response to tone value-color value conversion data.

The above arrangement is a device for creating color correction data for the purpose of easily realizing color correction data with high accuracy; however, the invention could also reside in a method based on a similar technical concept. Accordingly, a method invention would afford working effects basically similar to those above. When reducing the invention to practice, in some instances color correction data is created by execution of a predetermined program on a computer. The invention can be implemented as such a program as well.

Any kind of storage medium could be used to provide the program. For example, a magnetic recording medium or magnetooptical recording medium would be acceptable, and any recording medium that may be developed in future may be thought of in exactly the same manner. Whether realized in part by means of software and in part by means of hardware, the idea of the invention differs nowise, and includes arrangements wherein portions being recorded on a recording medium are read out appropriately as needed. The invention may also reside in a printing control device utilizing color correction data created in the above manner; a printing control method; or a printing control program.

### BRIEF DESCRIPTION OF THE DRAWINGS

FIG. 1 is a block diagram showing a simplified arrangement of a computer.

FIG. 2 is an illustration showing an example of large/medium/small allocation standard device data.

FIG. 3 is an illustration showing an example of patches.

FIG. 4 is a flowchart of the calibration process.

FIG. 5 is a diagram describing the process during color correction.

### DETAILED DESCRIPTION

Here, the embodiments of the invention shall be described herein in the order indicated hereinbelow.
(1) Arrangement of Printing Control Device:
(2) Calibration Process:
(3) Other Embodiments:
   (1) Arrangement of Printing Control Device:

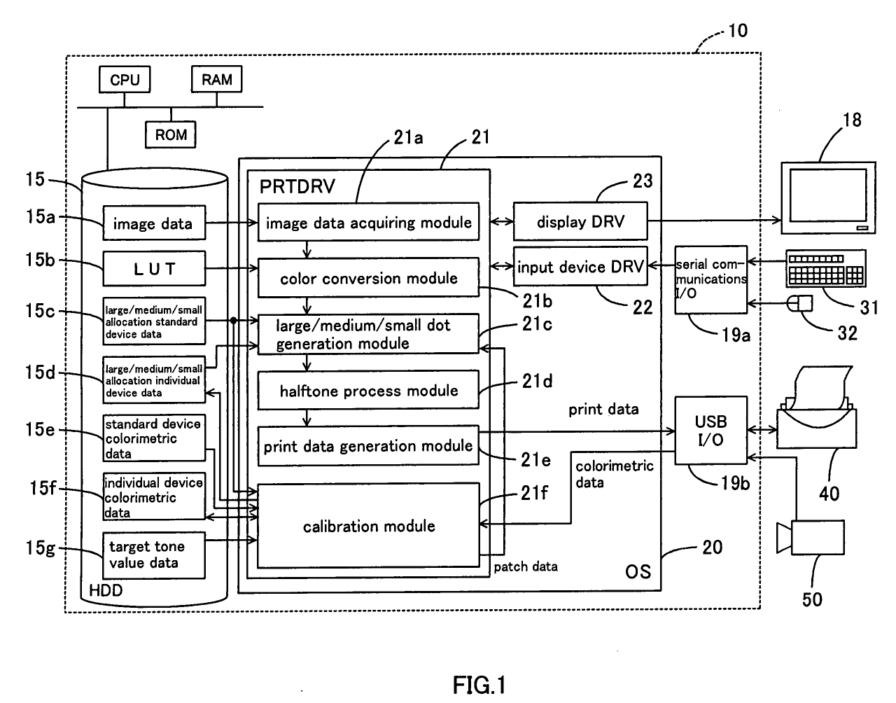

FIG. 1 is a block diagram showing a simplified arrangement of a computer serving as the printing control device. The computer 10 comprises a CPU which is the center of arithmetic processing, and storage media such as ROM and RAM; it is able to execute predetermined programs while utilizing peripherals such as an HDD 15. The computer 10 is connected via a serial communications I/O 19a with control input devices such as keyboard 31 and a mouse 32; also connected, via a video board not shown in the drawing, is a display 18 for display purposes. A printer 40 is also connected, through a USB I/O 19b.

A colorimeter 50 is also connected via the USB I/O 19b. The printer 40 in this embodiment comprises a mechanism for detachable installation ink cartridges for a plurality of colors of ink, each filled with ink of one color; and cartridges for CMYKlclm (cyan, magenta, yellow, black, light cyan, light magenta) inks. The printer 40 is able to combine these ink colors to produce a multitude of colors, whereby a color image is formed on the printing medium. Also, in this embodiment the printer 40 is able to eject three types of ink drops containing different ink levels, whereby it is possible to represent in single pixel with any of four tones. Herein, focusing upon ink drop size, ink drops shall be referred to as large, medium and small dots. While the printer 40 of this embodiment is an ink-jet printer, the invention is applicable to printers of various other types besides ink-let, such as laser printers.

An arrangement using chromatic inks of the six colors CMYKlclm is not mandatory, with arrangements using the four colors CMYK or the seven colors CMYKlclmDY (dark yellow) being acceptable as well. Of course, it would be acceptable to use other colors, for example R (red) and V (violet) in place of lclm, or to use dark and light inks for the K ink. In the colorimeter 50, a printout is illuminated with a known light source, and the reflected light is detected to detect the spectral reflectance of the printout; the color values can be output as CIELAB values (L*a*b* values) or XYZ values, for example.

In this embodiment, the CIELAB values of patches printed by the printer 40 are measured and output to the USB I/O 19b. The connection interface of the computer 10 and printer 40 and the connection interface of the computer 10 and colorimeter 50 need not be limited to those mentioned hereinabove, it being possible to employ instead various other connection modes such as parallel interface, SCSI connections, wireless connections, or the like, as well as any connection mode that may be developed in the future.

While in this embodiment the printing control device is composed of the computer 10, the printing control process of the invention could also be reduced to practice by means of a program execution environment on board the printer 40, with the printing control process being carried out on image data from a digital camera connected directly to the printer 40. Of course, in a similar arrangement the printing control process could be carried out by the digital camera; or the printing control process of the invention could be reduced to practice by means of distributed processing. The printing control process of the invention could be reduced to practice in a so-called multifunction device that integrates a scanner for scanning images with a printer for printing images.

On the computer 10 of this embodiment, the OS 20 incorporates a printer driver (PRTDRV) 21, an input device driver (DRV) 22, and a display driver (DRV) 23. The display DRV 23 is a driver that controls display of images, a printer properties screen, and the like on the display 18; the input device DRV 22 is a driver that receives code signals from the aforementioned keyboard 31 and mouse 32 input via the serial I/O 19a, and handles predetermined input operations.

The PRTDRV 21 is able to perform predetermined processes on images which an application program (not shown) has instructed be displayed, and on patch images (described later), to execute printing. For the purpose of executing printing, the PRTDRV 21 comprises an image data acquiring module 21a, a color conversion module 21b, a large/medium/small dot generation module 21c, a halftone process module 21d, and a print data generation module 21e. When an aforementioned print command is issued, the PRTDRV 21 is driven, whereupon the PRTDRV 21 sends data to the display driver DRV 23, and displays a UI (not shown) enabling input of information indicating printing medium, image quality, printing speed, and other printing conditions, and of a command to execute calibration.

When a user operates the keyboard 31 or mouse 32 and inputs via the UI information needed for printing, or performs a Print execute command, the modules of the PRTDRV 21 are run, and the pixel data contained in the image data is subjected to processing by the modules to generate print data. The print data so generated is output to the printer 40 via the USB I/O 19b, whereupon the printer 40 executes printing on the basis of the print data.

More specifically, the image data acquiring module 21a acquires image data 15a indicating the image targeted for printing. At this time, if the pixel count of the image data 15a is excessive or insufficient, an appropriate resolution conversion process is carried out to assure [the proper number of] pixels needed for printing. This image data 15a is data in dot matrix form specifying color of each pixel through tone representation of RGB (red, green, blue) color components; in this embodiment, it is image data in which each color has 256 tones, employing a color system in accordance with the sRGB specification.

In this embodiment, while the description takes the example of this image data 15a, data of various other kinds, such as JPEG image data employing the YCbCr color system or image data employing the CMYK color system, could be used instead. Of course, the invention is also applicable to data conforming to the Exif 2.2 Standard (Exif is a registered trademark of the Japan Electronic Industry Development Association), and to data corresponding to Print Image Matching (PIM: PIM is a registered trademark of Seiko Epson Corp.).

The color conversion module 21b is a module for converting the color system that represents pixel color; referring appropriately to a LUT (color conversion table) 15b stored on the HDD 15, it converts the sRGB color system of the image data 15a into the CMYKlclm color system having as components the ink colors (CMYKlclm) installed in the printer 40. The LUT 15b is a table that represents and associates with one another the respective colors of the sRGB color system and the CMYKlclm color system, describing this association relationship for a plurality of colors. Accordingly, for any color represented in the sRGB color system, by referring to sRGB colors specified in the LUT 15b, which colors surround [the color in question], it is possible by means of interpolation to calculate a color in the CMYKlclm color system corresponding to the color in question, to carry out color conversion.

The CMYKlclm color system data is data giving tone representation of each of the colors CMYKlclm in 256 tones, with each tone value corresponding to an ink level of each color for each pixel. That is, a tone level of 0 represents a state in which no inks of any color are recorded, whereas a tone level of 255 represents a state in which each color of ink is recorded at maximum level. It is possible to employ various arrangements whereby, over the range of tone values of 0-255, tone value change and ink level change are associated in linear fashion, tone value change and lightness change are associated in linear fashion, or the like.

As noted, the printer 40 in this embodiment is able to eject large/medium/small dots; the large/medium/small dot generation module 21c, on the basis of the aforementioned 256-tone CMYKlclm data, effects conversion to data indicating recording levels of large/medium/small dots for each color. Specifically, on the HDD 15 there is stored large/medium/small allocation standard device data 15c that associates CMYKlclm tone values with tone values representing large/medium/small dot recording levels; the large/medium/small dot generation module 21c refers to the large/medium/small allocation standard device data 15c and converts CMYKlclm tone values to large/medium/small dots for each color.

In this embodiment, large/medium/small dot tone number is greater than CMYKlclm tone number, and is represented on 12 bits (4096 tones). In large/medium/small dot tone values, a tone level of 0 represents a state in which no large/medium/small dots are recorded, and a tone level of 4096 represents a state in which large/medium/small dots are recorded at maximum level. It is possible to employ various arrangements whereby, over the range of tone values of 0-4095, tone value change and dot number change of large/medium/small ink drops are associated in linear fashion, tone value change and lightness change with large/medium/small ink [dots] in the recorded state are associated in linear fashion, or the like.

Large/medium/small dot tone values can be determined by various methods. For example, these can be determined by associating tone values of large dots only with CMYKlclm tone values of 0-255 in order to represent CMYKlclm tone changes by large dots only, and subsequently substituting some of the large dots with small dots and/or medium dots of equivalent lightness. In making this determination, large/medium/small dot recording levels care determined so as to avoid causing banding or bleeding during substitution in the manner described above.

The large/medium/small allocation standard device data 15c stored in advance on the HDD 15 is data determined for a standard printer. Specifically, in the printer 40 production stage, the manufacture of the printer 40 prepares a standard device, and with reference to the large/medium/small allocation standard device data 15c, adjusts ink ejection levels such that when printing is carried out with an individual printer 40, the output color is substantially equivalent to the output color of the standard device. In this embodiment, when an individual printer 40 is shipped, this large/medium/small allocation standard device data 15c is recorded onto a predetermined recording medium, and when installed on the computer 10 is copied from the recording medium to the HDD 15. In this embodiment, in the initial state, reference is made to the large/medium/small allocation standard device data 15c, but after a calibration process (described later), reference is made to large/medium/small allocation individual device data 15d. Additionally, in this embodiment, the large/medium/small allocation standard device data 15c corresponds to the tone value-recording rate conversion data mentioned previously.

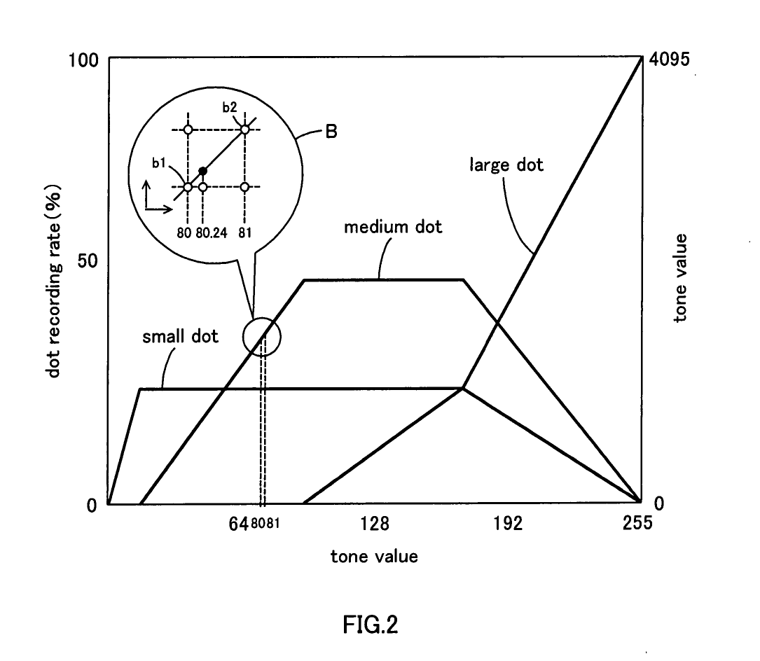

FIG. 2 is an illustration showing an example of large/medium/small allocation standard device data 15c. In the drawing, there is shown large/medium/small allocation standard device data for a certain color, with CMYKlclm tone value indicated on the horizontal axis and large/medium/small ink drop recording level indicated on the vertical axis. Also, in FIG. 2 ink recording level is indicated both in terms of tone value and dot recording rate (%), with tone value (0-4095) indicated on the vertical axis at right and dot recording rate indicated on the vertical axis at left. Here, “dot recording rate” refers to the proportion of pixels having dots formed thereon among the pixels of an area, when a uniform area is reproduced according to a give tone value.

In this embodiment, as noted previously, utilizing the fact that large/medium/small dot tone number is greater than CMYKlclm tone number, color reproduction is achieved with high accuracy. That is, if CMYKlclm tone number and large/medium/small dot tone number are the same, for the minimum change of “1” a CMYKlclm tone value, the corresponding minimum change in a large/medium/small dot tone value will be “1” as well. However, if CMYKlclm tone number is greater than large/medium/small dot tone number, the minimum change of “1” in a large/medium/small dot tone value can correspond to a change smaller than the minimum change of “1” a CMYKlclm tone value. Accordingly, it becomes possible to achieve color reproduction with high accuracy, by means of correcting CMYKlclm tone value at a level below the decimal point.

The halftone process module 21d, making reference to large/medium/small dot tone values, carries out a halftone process that reduces recording equivalent to ink levels corresponding to tone values, into a tone number for each pixel for the purpose of being realized by the printer 40. That is, it generates halftone image data specifying, for each pixel, ink ejection on/off state and ink level for ejection (either large, medium, or small). The print data generation module 21e receives the halftone image data, sorts it in the order in which it will be used by the printer, and outputs the data serially to the printer in units equivalent to that used for a single main scan.

Specifically, an ink nozzle array is disposed as the ink ejection device on the printer 40; since in the nozzle array a plurality of ejection nozzles are arranged in parallel in the sub-scanning direction, data spaced several dots apart in the sub-scanning direction is used at the same time. Accordingly, data that, of data lined up in the sub-scanning direction, is to be used at the same time is sorted in order so as to be buffered at the same time in the printer 40. The print data generation module 21e then appends predetermined information, e.g. image resolution etc., to the sorted data to generate print data, which is sent to the printer via the USB I/O 19b. Once all the data needed to form the image has been transferred to the printer, the image is formed on a printing medium by the printer 40.

In an arrangement whereby printing is executed in the above manner, it may occur that output color of an individual printer 40 deviates from output color of the standard printer, due to change over time of the printer 40 or the like. In this embodiment, the operator of the computer 10, by means of issuing a command through the aforementioned UI, can perform calibration in order to eliminate the deviation in color. The calibration module 12f assumes control during this calibration. Specifically, by means of a control process by the calibration module 12f, large/medium/small allocation individual data 15d is generated and recorded on the HDD 15.

After the large/medium/small allocation individual data 15d has been recorded, the large/medium/small dot generation module 21c, referring to the large/medium/small allocation individual data 15d, determines large/medium/small dot tone values, whereby printing can be carried out under conditions of compensated color deviation. Accordingly, the process of carrying out conversion with reference to the large/medium/small allocation individual data 15d in the color conversion module 21b and the large/medium/small dot generation module 21c is equivalent to the process in the aforementioned tone value conversion portion; and the printing process carried out on the basis of the converted data in the halftone process module 21d and print data generation module 21e is equivalent to the process in the aforementioned printing execution portion.

In this embodiment, for the purpose of the calibration process, standard device calorimetric data 15e and target tone value data 15g are created in advance and stored on a predetermined recording medium. This data is then copied from the recording medium to the hard disk HDD 15 at the time of installation. Here, target tone value data 15g is data specifying a plurality of CMYKlclm tone values, and in this embodiment is data derived by extracting a plurality of tone values in a generally uniform manner from all CMYKlclm tone values. The calibration module 12f refers to the target tone value data 15g and creates patch data for the purpose of ascertaining output color in an individual printer 40, and output the plurality of patches to the printer 40.

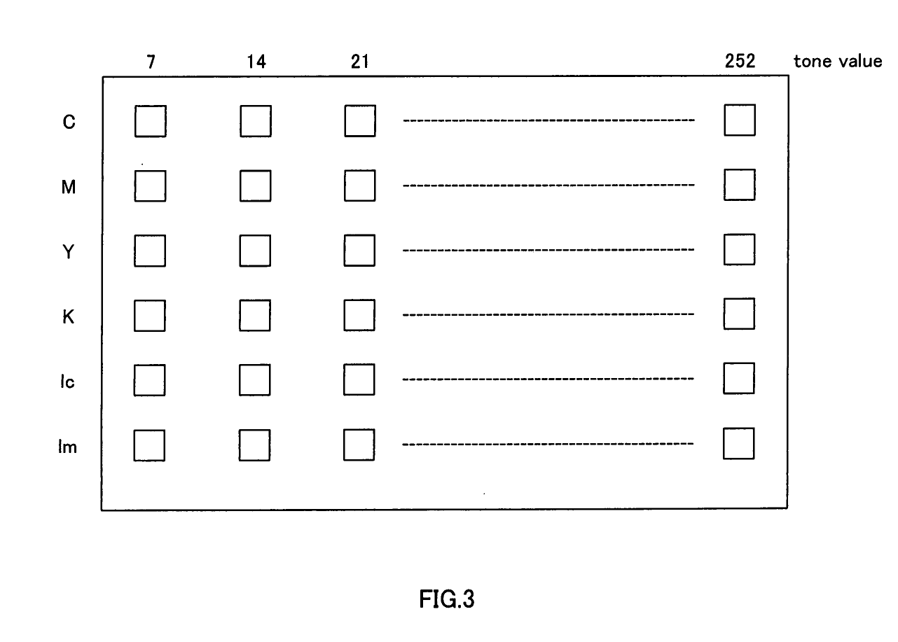

FIG. 3 is an illustration showing an example of rectangular patches created on the basis of target tone value data 15g, and printed out. In the drawing, the large rectangle indicates the printing medium, at the upper edge of which is indicated tone value and at the left edge of which are indicated ink colors. Since a larger tone value means a greater ink level, for the patches shown in the drawing, patches on the4 left side are brighter, becoming progressively darker moving rightward. In this embodiment, as shown in the drawing patches are printed for all colors, and calibration is performed for each ink color.

The calibration module 21f acquires calorimetric data measured by the colorimeter 50, and stores it as individual device calorimetric data 15f on the HDD 15. That is, colorimetric data indicating color values (CIELAB values etc.) derived by color measurement of the patches shown in FIG. 3 is designated as individual colorimetric data 15f. Then, large/medium/small allocation individual data 15d is created on the basis of the individual device calorimetric data 15f and the aforementioned standard device colorimetric data 15e. The standard device calorimetric data 15e is data indicating CIELAB values, obtained by printing patches similar to the patches in FIG. 3 and measuring them with a colorimeter. In this embodiment, the standard device colorimetric data 15e is equivalent to the tone value-color value conversion data mentioned previously.

(2) Calibration Process:

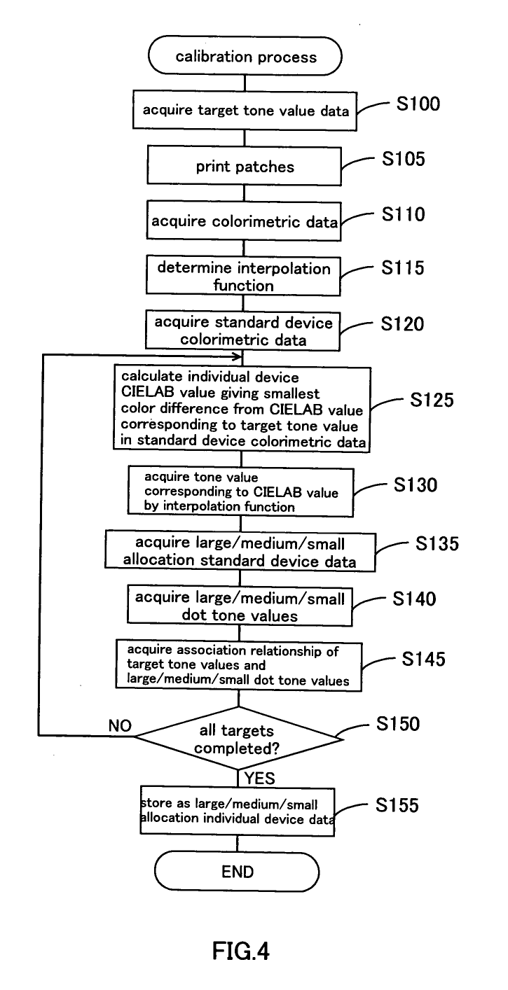

The following detailed description of the calibration process referred to previously is based on the flow shown in FIG. 4. The PRTDRV 21 comprises the calibration module 21f; the calibration module 21f can be run by means of making a command to execute calibration from the printer Properties screen. When the calibration module 21f is run, first, in Step S100, target tone value data 15g is acquired from the HDD 15.

In Step S105, tone values of each ink color are ascertained from the target tone value data 15g, patch data for the purpose of executing printing at the tone values in question is created, and patches are printed. Specifically, this patch data is transferred to the large/medium/small dot generation module 21c, whereupon the large/medium/small dot generation module 21c refers to the transferred patch data and the large/medium/small allocation standard device data 15c, and creates patch data in which patch color is represented by large/medium/small dot tone values. This patch data is converted to print data by means of processing in the aforementioned halftone process module 21d and print data generation module 21e.

The user measures the color of each printed patch using the colorimeter 50. In Step S110, the calibration module 21f outputs control data for outputting the colorimetric data via the USB I/O 19b, whereupon the colorimeter 50, in response to the control data, outputs calorimetric data that indicates CIELAB values of each patch. The calibration module 21f acquires the colorimetric data and stores it as individual device colorimetric data 15f on the HDD 15. Steps S105 and S110 described above are equivalent to the process in the aforementioned color value acquiring portion.

The calibration module 21f compares this individual device calorimetric data 15f, corrects large/medium/small dot tone values in such a way as to output color that approximates as closely as possible the color that should properly be output at the target tone values, and creates the aforementioned large/medium/small allocation individual device data 15d. First, in Step S115, there is calculated an interpolation function for the purpose of acquiring CIELAB values for an CMYKlclm tone values in an individual printer.

This interpolation function is a function created with reference to the association relationship of the plurality of target tone values indicated in the aforementioned individual device calorimetric data 15f, and CIELAB values; the function describes in approximate terms an association relationship between the two among the target tone values. Any of various methods can be employed as the method for calculating this function; for example, it would be possible to determine in advance a functional form for a high-order function having tone value or CIELAB value as a variable, and to determine a function by calculating the high-order function coefficients from CIELAB value at each tone value. Of course, since calorimetric data will include measurement error, rather than strictly association tone values and CIELAB values, it is possible to employ any of various arrangements such as making the extent of change of the function as smooth as possible, or minimizing overall error of CIELAB values and values derived by means of the interpolation function. Once the interpolation function has been derived, data indicating the interpolation function is stored in RAM etc., not shown.

In Step S120, there is acquired the standard device colorimetric data 15e that has been stored in advance in the HDD 15. Next, in Steps S125-S145, color that should properly be output by a target tone value is specified, a CIELAB value for outputting the color that should properly be output with the individual printer 40 is calculated, and a large/medium/small dot tone value for obtaining output of that CIELAB value is acquired. The acquired large/medium/small dot tone value is associated with the target tone value.

Specifically, in Step S125, referring to the standard device colorimetric data 15e, a CIELAB value corresponding to a certain target tone value is acquired. In Steps S125-S150, the process proceeds with this target value as the process target. In Step S125, from among CIELAB values derived by means of interpolation function mentioned previously, there is calculated a CIELAB value giving the smallest color difference with respect to the acquired CIELAB value. That is, for each ink color, there is acquired a color outputtable by the individual printer 40, which color most closely approximates the output color at the target tone value in the standard device colorimetric data 15e.

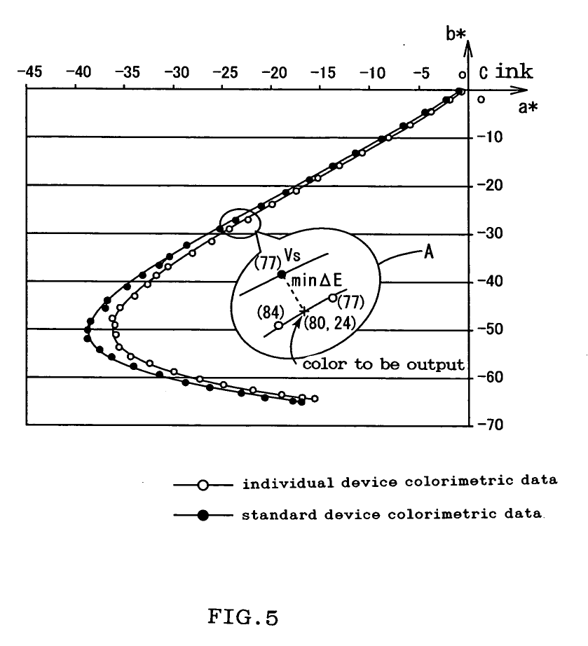

FIG. 5 is a diagram describing this process. In the figure, a* value in the L*a*b* color space is given on the horizontal axis, and b* value is given on the vertical axis. That is, CIELAB values (L*a*b* values) in the L*a*b* color space, which is a three-dimensional color space, are shown projected onto the a*b* plane.

In the drawing, a condition in which color values for C ink are plotted is shown by way of example. The white circles in the drawing are projected values of the individual device colorimetric data 15f, and are color values corresponding, in order along the curve from the white circle closest to the origin O, to tone values of “7, 14, . . . , 252.” The black circles in the drawing are projected values of the standard device calorimetric data 15e, and are color values corresponding, in order along the curve from the black circle closest to the origin O, to tone values of “7, 14, . . . , 252.”

In Enlargement A in FIG. 5, the white dots shown as individual device calorimetric data 15f are CIELAB values of color that the individual printer 40 will print by means of target tone values of 77 and 84; the curve in proximity thereto is a projection of CIELAB values calculated by means of the interpolation function described above. Similarly, the black dot shown as standard device colorimetric data 15e is the CIELAB value (Vs) of color that the standard printer will print by means of a target tone value of 77.

In the individual printer 40, when color is output while varying tone value for each color, the CIELAB value thereof will be substantially equivalent to the CIELAB value calculated by means of the interpolation function described above (i.e. situated on the projection curve in FIG. 5). Accordingly, in order to eliminate color deviation by means of correcting each color, there is extracted a CIELAB value that, of CIELAB is extracted values calculated by means of the interpolation function, is as close as possible to the value Vs. Thus, in Step S125 mentioned above, there is calculated a CIELAB value which is calculated by means of the interpolation function and which has the smallest color difference (min ΔE) with respect to the aforementioned value Vs.

In Step S130, the tone value corresponding to the CIELAB value with the aforementioned smallest color difference on the basis of the interpolation function is acquired. In the example shown in FIG. 5, this tone value is 80.24. In this embodiment, by defining the interpolation function continuously, it is possible to define values that are smaller than integral values as well, to calculate tone values that include values below the decimal point as well. At this point in time, it is ascertained that the correction level of the tone value in the individual printer 40, i.e. that needed for the individual printer 40 to output the color that should properly be output at a target tone value of 77, requires correcting the tone value by 3.24, to 80.24.

Once the tone value in question has been ascertained, in Step S135, the aforementioned standard device calorimetric data 15e is acquired, and in Step S140 a large/medium/small dot tone value corresponding to the tone value is acquired. Then, in Step S145, the acquired large/medium/small dot tone value and the target tone value targeted for the process of the aforementioned Step S125 and subsequent are associated with one another and stored in RAM, not shown. That is, for the target tone value in question, association is carried out in such a way as to output an ink drop by means of the large/medium/small dot tone value acquired in Step S140.

Here, correction of color deviation with a high degree of accuracy by means of extracting a large/medium/small dot tone value equivalent to a CMYKlclm tone value below the decimal point, and prevention of tone collapse and tone jumping is described with reference to Enlargement B in FIG. 2. Enlargement B shows an example of a case wherein the color that should properly be output at a target tone value of 77 is equivalent to a tone value of 80.24, as in the example mentioned previously. The straight line in the Enlargement shows tone Value of medium dots specified by the standard device colorimetric data 15e; when only integral values of CMYKlclm tone values are considered, only values of b1 or b2, corresponding to CMYKlclm tone values of 80 or 81, will be selectable as tone values for medium dots.

However, the correct color that should be output for a target tone value of 77 is equivalent to a tone value of 80.24. In this embodiment, since the tone number of large/medium/small dot tone values is 4096, an intermediate value of value b1 or b2 can be selected, so that a more accurate large/medium/small dot tone value can be associated with the target tone value 77. That is, if only integral values are considered as CMYKlclm tone values, it will not be possible to select accurate large/medium/small dot tone values by means of correction, resulting in output color that is not the same as the color that should properly be output, or in output of different colors for colors that should be output with identical color, so that tone collapse or tone jumping occurs; in this embodiment, however, tone collapse and tone jumping due to such causes does not occur.

Selectable large/medium/small dot tone values are those tone values determined in advance in the standard device colorimetric data 15e. That is, any recording level balance of large/medium/small dots specified in advance in the standard device colorimetric data 15e is selected. In the standard device calorimetric data 15e, large/medium/small dot balance and recording level are determined through extremely fine adjustments in consideration of numerous conditions for the purpose of printing high quality images. Accordingly, when correcting for color deviation, if the device calorimetric data 15e is ignored, and correction is carried out arbitrarily, for example, with a focus on adjusting the CIELAB value in FIG. 2, by increasing the small dot recording level while decreasing the medium dot recording level, there is a risk that image quality will be degraded. In this embodiment, however, since large/medium/small dot tone values defined in the standard device colorimetric data 15e are used as-is, color correction can be carried out without degrading image quality.

When large/medium/small dot tone values and target tone values are associated with one another in Step S145 in the above manner, in Step S150, a decision is made as to whether processing of all of the aforementioned plurality of target tone values as process targets has been completed, and the process starting with Step S125 is repeated until in Step S150 it is decided that processing has been completed for all of the plurality of target tone values. Once it is decided in Step S150 that processing has been completed for all of the plurality of target tone values, the association relationship stored in RAM (not shown) is stored as large/medium/small allocation individual device data 15d on the HDD 15 (Step S155). In this way, the process in Step S115 and Steps S125 S150 is equivalent to the process in the aforementioned recording level acquiring portion, the process in Step S120 is equivalent to the aforementioned recording level specifying data acquiring portion, and the process in Step S155 is equivalent to the process in the aforementioned color correction data creation portion.

In the large/medium/small allocation individual device data 15d created in the above manner, a plurality of target tone values and large/medium/small dot tone values are associated with one another for each color, and according to the associated large/medium/small dot tone values, color that is a close as possible to the color that should be output by target tone values can be output. Accordingly, the large/medium/small dot creation module 21c, by converting any CMYKlclm tone values to a large/medium/small dot tone values with reference to the large/medium/small allocation individual device data 15d, can execute printing while correcting for color deviation of an individual printer 40 with respect to the standard device.

In the present invention, correction is carried out for each ink color to eliminate color deviation; however, the target for correction is data for the purpose of large/medium/small allocation, with CMYKlclm tone values specified by the LUT 15b being unchanged, to modify the association relationship between CMYKlclm tone values and large/medium/small dot tone values. Accordingly, tone collapse and tone jumping can be prevented. Further, the arrangement is such that large/medium/small dot tone number is greater than CMYKlclm tone value tone number, and tone change equivalent to below the decimal point of CMYKlclm tone values is contemplated. Accordingly, correction of color deviation can be carried out with high accuracy.

(3) Other Embodiments

The embodiment hereinabove is simply one embodiment of the invention, and it is of course possible to employ other arrangements. For example, when comparing standard device calorimetric data 15e with color in an individual device in order to identify color that should properly be output by target tone values, an arrangement whereby color that minimizes hue difference, brightness difference, or saturation difference, rather than color difference, is calculated may be employed as well. With such an arrangement, the interpolation function can be made extremely simple, and it is possible to reduce the processing load as well.

Calibration in the embodiment described hereinabove is carried out by adjustment that involves correcting tone values on a monochrome level so as to match output color with monochrome output in a standard printer, by the invention is not limited to application in calibration of this kind. For example, the invention could be implemented in calibration carried out by means of contemplating a combination of a plurality of colors, so as to adjust color balance.

Specifically, color that should be output by target tone values combining a plurality of inks is ascertained, large/medium/small dot tone values that give color most closely approximating this color are ascertained, and these are associated with the aforementioned target tone values to produce large/medium/small allocation individual device data 15d. With this arrangement as well, it is possible by means of a simple operation to maintain high image quality, while carrying out correction of color deviation with a high degree of accuracy.

Further, it is possible to employ various arrangements for target tone values, values not being limited to those extracted uniformly from all tone values as described hereinabove. For example, there could be employed an arrangement whereby tone values that indicate high ink recording levels are selected as target tone values in relatively greater numbers. Typically, even where ink recording level increases in linear fashion, the lightness thereof does not decline in linear fashion, with non-linearity becoming more pronounced at lower lightness. Accordingly, by selecting target tone values at the low lightness end in relatively greater numbers, it is possible to carry out correction of color deviation accurately.

Further, whereas in the embodiment hereinabove, the arrangement is one in which the calibration module 21f is provided as part of the functionality of the PRTDRV 21, so that the user of the individual printer 40 can carry out calibration, the subject carrying out calibration is of course not limited to the user of an individual printer. For example, an arrangement whereby the manufacturer of the printer 40 utilizes the invention when adjusting output color of a printer 40 at the time of shipping, so that it matches a standard printer. In this case, the calibration module 21f could provide as part of the functionality of the PRTDRV 21, or the manufacturer could prepare a computer that executes a function equivalent to the function of the calibration module 21f.

1. Color correction data creation device for creating color correction data for the purpose of correcting deviation of color printed by a printing device capable of recording onto a printing medium N types (N is an integer of 2 or greater) of ink drops with different ink levels, the color correction data creation device comprising:
a recording level specifying data acquiring portion that acquires recording level specifying data specifying standard ink recording levels for the purpose of performing output at predetermined color values by means of said N types of ink drops;
a color value data acquiring portion that acquires color value data indicating color values of color to be printed by means of target tone values that specify target color for output by a printing device;
a recording level acquiring portion that with reference to said color value data specifies color values of color to be output by means of said target tone values, and with reference to said recording level specifying data acquires, for said N types of ink drops, ink recording levels corresponding to said color to be output; and
a color correction data creation portion that creates color correction data associating said acquired ink recording levels and said target tone values.

2. Color correction data creation device according to claim 1 wherein said recording level specifying data includes tone value-recording rate conversion data that indicates an association relationship between target tone values and recording levels of N types of ink drops that should be printed onto a printing medium when printing with a standard printing device target color indicated by said target tone values; and tone value-color value conversion data that indicates an association relationship between target tone values and color values of color printed with a standard printing device by means of said target tone values.

3. Color correction data creation device according to claim 2 wherein tone number of said target tone values in said tone value-recording rate conversion data is smaller than tone number of tone values indicating recording levels of said ink drops; and said tone value-color value conversion data is data enabling calculation of an association relationship between target tone values and color values for a greater number of values than the tone number of target tone values.

4. Color correction data creation method for creating color correction data for the purpose of correcting deviation of color printed by a printing device capable of recording onto a printing medium N types (N is an integer of 2 or greater) of ink drops with different ink levels, the method comprising:
a recording level specifying data acquiring step wherein there is acquired recording level specifying data specifying standard ink recording levels for the purpose of performing output at predetermined color values by means of said N types of ink drops;
a color value data acquiring step wherein there is acquired color value data indicating color values of color to be printed by means of target tone values that specify target color for output by a printing device;
a recording level acquiring step wherein with reference to said color value data there are specified color values of color to be output by means of said target tone values, and with reference to said recording level specifying data there are acquired, for said N types of ink drops, ink recording levels corresponding to said color to be output; and
a color correction data creation step wherein there is created color correction data associating said acquired ink recording levels and said target tone values.

5. Color correction data creation program product for creating color correction data for the purpose of correcting deviation of color printed by a printing device capable of recording onto a printing medium N types (N is an integer of 2 or greater) of ink drops with different ink levels, the color correction data creation program product including the following program code:
recording level specifying data acquiring program code that acquires recording level specifying data specifying standard ink recording levels for the purpose of performing output at predetermined color values by means of said N types of ink drops;
color value data acquiring program code that acquires color value data indicating color values of color to be printed by means of target tone values that specify target color for output by a printing device;
recording level acquiring program code that with reference to said color value data specifies color values of color to be output by means of said target tone values, and with reference to said recording level specifying data acquires, for said N types of ink drops, ink recording levels corresponding to said color to be output; and
color correction data creation program code that creates color correction data associating said acquired ink recording levels and said target tone values.

6. Printing control device for controlling a printing device capable of recording onto a printing medium N types (N is an integer of 2 or greater) of ink drop with different ink levels, the printing control device comprising:
an image acquiring portion that acquires image data indicating color of pixels making up an image, as tone values of each color component;
a tone value conversion portion that converts tone values of each color component in said image data to recording levels of said N types of ink drops, making reference to color correction data created by acquiring recording level specifying data specifying standard ink recording levels for the purpose of performing output at predetermined color values by means of said N types of ink drops, acquiring color value data indicating color values of color to be printed by means of target tone values that specify target color for output by a printing device, with reference to said color value data specifying color values of color to be output by means of said target tone values, and with reference to said recording level specifying data acquiring, for said N types of ink drops, ink recording levels corresponding to said color to be output, and associating said acquired ink recording levels with said target tone values; and
a printing execution portion that generates print data for the purpose of recording ink drops on the basis of said converted recording levels, and outputs it to said printing device.

7. Printing control method for controlling a printing device capable of recording onto a printing medium N types (N is an integer of 2 or greater) of ink drop with different ink levels, the method comprising:
an image acquiring step wherein there is acquired image data indicating color of pixels making up an image, as tone values of each color component;
a tone value conversion step wherein tone values of each color component in said image data are converted to recording levels of said N types of ink drops, making reference to color correction data created by acquiring recording level specifying data specifying standard ink recording levels for the purpose of performing output at predetermined color values by means of said N types of ink drops, acquiring color value data indicating color values of color to be printed by means of target tone values that specify target color for output by a printing device, with reference to said color value data specifying color values of color to be output by means of said target tone values, and with reference to said recording level specifying data acquiring, for said N types of ink drops, ink recording levels corresponding to said color to be output, and associating said acquired ink recording levels with said target tone values; and
a printing execution step wherein print data for the purpose of recording ink drops is generated on the basis of said converted recording levels, and outputs it to said printing device.

8. Printing control program product for controlling a printing device capable of recording onto a printing medium N types (N is an integer of 2 or greater) of ink drop with different ink levels, the printing control program product including the following program code:
image acquiring program code that acquires image data indicating color of pixels making up an image, as tone values of each color component;
tone value conversion program code that converts tone values of each color component in said image data to recording levels of said N types of ink drops, making reference to color correction data created by acquiring recording level specifying data specifying standard ink recording levels for the purpose of performing output at predetermined color values by means of said N types of ink drops, acquiring color value data indicating color values of color to be printed by means of target tone values that specify target color for output by a printing device, with reference to said color value data specifying color values of color to be output by means of said target tone values, and with reference to said recording level specifying data acquiring, for said N types of ink drops, ink recording levels corresponding to said color to be output, and associating said acquired ink recording levels with said target tone values; and
printing execution program code that generates print data for the purpose of recording ink drops on the basis of said converted recording levels, and outputs it to said printing device.
